(19) United States
(12) Patent Application Publication
(10) Pub. No.: US 2012/0279037 A1
(43) Pub. Date: Nov. 8, 2012

(54) SYSTEM OF RECLOSABLE STORAGE BAG REFILLS FOR A DISPENSING CONTAINER

(76) Inventors: Jamie Grace Thomas, Milwaukee, WI (US); William D. Price, Midland, MI (US); Robert J. Nestle, Essexville, MI (US); Randall W. Friebe, Bay City, MI (US); Katherine N. Bouchey, Milwaukee, WI (US); Jonathan D. Bellante, Milwaukee, WI (US)

(21) Appl. No.: 13/100,367

(22) Filed: May 4, 2011

(51) Int. Cl. B23P 11/00

(52) U.S. Cl. 29/428

(57) ABSTRACT

A process for providing a recloseable storage bag to a consumer. The process the process includes steps of: (a) providing a plurality of recloseable storage bags; and (b) directing consumers to load the plurality of recloseable storage bags into an in-home dispenser.

### CROSS REFERENCE TO RELATED APPLICATIONS

Not Applicable.

### REFERENCE REGARDING FEDERALLY SPONSORED RESEARCH OR DEVELOPMENT

Not Applicable.

### SEQUENTIAL LISTING

Not Applicable.

### FIELD OF THE INVENTION

Our invention relates to a method and apparatus for providing recloseable storage bags to consumers, particularly our invention relates to a system for providing a delightful consumer experience from the beginning through to the end of a user-experience when a consumer purchases, stores, and/or dispenses recloseable storage bags.

### BACKGROUND OF THE INVENTION

There is increasing competition for consumers' business. Given the sheer number of options that consumers have in many fields, such as home storage, many producers of home storage products, such as plastic food bags like those provided by the Ziploc® brand (S.C. Johnson & Son, Inc., Racine, Wis.) have been forced into a so-called “race for the bottom” price-wise when selling these products due to the massive amount of competition from unbranded competition riding the coattails of the advertising of larger companies, such as Ziploc® Brand bags.

Major producers of such recloseable storage bags have made a number of strides to differentiate themselves from a purely technical aspect by providing, inter alia, freezer optimized usage, distinctly colored closure strips, optimally spaced zippers, clicking zippers, and highly functionalized slider closures. While many of these technical advancements have provided good points of differentiation, unbranded bags have continued to make significant headway into the market share for plastic recloseable storage bags.

Thus, there is a need for a system or method for marketing or providing recloseable storage bags in such a way that the consumer is provided with an overall experience that clearly differentiates itself from those provided by unbranded producers. In particular, there is a need for a system or method for marketing or providing recloseable storage bags in such a way that addresses currently unmet user needs that are not fixable through technical changes to the bag alone—that is, providing the user with a better overall experience from the retail shelf to an in-use occasion.

### SUMMARY OF THE INVENTION

In a first nonlimiting embodiment, the present invention is directed to a process for providing a recloseable storage bag to a consumer wherein the process comprises the steps of: (a) providing a plurality of recloseable storage bags; and (b) directing consumers to load the plurality of recloseable storage bags into an in-home dispenser.

In a second nonlimiting embodiment, the present invention is directed to a process for providing a recloseable storage bag to a consumer wherein the process comprises the steps of: (a) providing a plurality of recloseable storage bags in a flexibly wrapped package; wherein the flexibly wrapped package is substantially cylindrical; and (b) directing consumers to load the plurality of recloseable storage bags into an in-home dispenser.

In a third nonlimiting embodiment, the present invention is directed to a process for providing a recloseable storage bag to a consumer wherein the process comprises the steps of: (a) providing a plurality of recloseable storage bags; and (b) directing consumers to load the plurality of recloseable storage bags into an in-home dispenser; wherein the in-home dispenser comprises one or more compartments.

### BRIEF DESCRIPTION OF THE DRAWINGS

FIG. 1 provides a perspective view of one embodiment of an exemplary recloseable storage bag according to the Prior Art.

FIG. 2 provides a cross-sectional view of one embodiment of a box containing recloseable storage bags along line 2-2 of FIG. 3 according to the Prior Art.

FIG. 3 provides a perspective view of an exemplary embodiment of a box according to the Prior Art.

FIG. 4 provides a flow chart of one embodiment of a process for providing recloseable storage bags to a consumer according to the present invention.

FIG. 5 provides a perspective view of an embodiment of a flexibly wrapped package of recloseable storage bags according to the present invention.

FIG. 6(a) provides a perspective view of an embodiment of a base of an in-home dispensing unit according to the present invention.

FIG. 6(b) provides a perspective view of an embodiment of a base and lid of an in-home dispensing unit according to the present invention.

FIG. 6(c) provides a perspective view of an embodiment of a volume insert according to the present invention.

FIG. 7(a) provides a side view of an embodiment of a symmetrically folded bag according to the present invention.

FIG. 7(b) provides a side view of an embodiment of a symmetrically folded bag loaded into a dispensing device taken along line 7(b)-7(b) of FIG. 6(b), according to the present invention.

FIG. 8 provides a side view of an embodiment of a plurality of recloseable storage bags about a shape holder according to the present invention.

FIG. 9(a) provides a side view of an embodiment of a plurality of recloseable storage bags in a staggered configuration according to the present invention.

FIG. 9(b) provides a side view of an embodiment of a plurality of recloseable storage bags in a staggered configuration according to the present invention.

FIG. 10 provides a perspective view of an embodiment of a merchandiser according to the present invention.

### DETAILED DESCRIPTION OF THE INVENTION

The present invention is directed to a system and method for providing a user with an ideal experience from the point of purchase to the time of use when she uses a recloseable storage bag. In certain embodiments the system comprises at least three units: (1) a plurality of recloseable storage bags, such as the Ziploc® Brand Quart Sized Storage Bags provided in a flexible, or otherwise minimized outer wrap; (2) an in-store dispenser for providing such flexibly packaged, or otherwise minimized, bundles of storage bags; and (3) a dispensing unit for in-home use wherein the dispenser may be filled or loaded using the bags from the flexibly wrapped plurality. In certain embodiments, the plurality of bags are provided such that upon removal from their flexible, or otherwise minimized, packaging and immediately loaded into the dispenser wherein the loaded dispenser will neatly provide one bag at a time without having other unwanted bags pop out and such.

### Definitions

As used herein, the term “recloseable storage bag” or “bag” encompasses a broad range of structures and products designed to contain items, such as meats, cheeses, vegetables, fruits, breads, and the like. A nonlimiting example is a zippered plastic bag such as the Ziploc® Brand Sandwich Bag (S.C. Johnson & Son, Inc., Racine, Wis.). It is also apparent that such “recloseable storage bags” may be used to store non-comestibles, such as office supplies and household items such as nuts and bolts. In particular embodiments, recloseable storage bags are recloseable food storage bags. In certain embodiments, recloseable storage bags further comprise one or more bag closures. In certain other embodiments, recloseable storage bags are individually separated and do not comprise rolls of bags which may be separated by tearing along perforations, cutting along ends, or otherwise mechanically separating one bag from another as the bags are provided to a user at the point of first use. In another nonlimiting embodiment, bags may be quart or gallon sized. One of skill in the art will appreciate that any size of recloseable food storage bag size may be appropriate.

As used herein, “retail location” refers to a grocery store, mass merchandise store, drug store, club store, or other outlet where a consumer may purchase products for use. An online retailer may also provide any of the tangible elements of the present invention such as recloseable storage bags and/or the in-home dispensing unit.

As used herein, “flexibly wrapped package” refers to a container or outer covering for holding a plurality of recloseable storage bags, or other home storage products, together, in which the plurality of retail-storage containers or products is provided for in the retail location at the point of sale to customers. In some nonlimiting embodiments, the container or outer covering is not substantially rigid and may comprise materials such as LDPE, LLDPE, HDPE, BOPP, or other polyolefin resin blend. In yet another embodiment, a flexibly wrapped package is a package which has less internal volume compared to a traditional box. For example, in a particular nonlimiting embodiment, a flexibly wrapped package has less volume than a box, or rectangular prism, of the same width. Nonlimiting examples are cylindrical prisms, triangular prisms, octagonal prisms, hexagonal prisms, and the like. In certain other embodiments a flexibly wrapped package is cardboard or another paper-based material.

As used herein, “in-home dispensing device” refers to a refillable box, container, or other device which may be provided with a plurality of recloseable storage bags wherein the recloseable storage bags may be dispensed in a manner that minimizes consumer dissatisfaction. In a nonlimiting embodiment, an in-home dispensing device may be designed to provide for the dispensation of multiple sizes of recloseable storage bags or multiple openings or areas for dispensation of the like-sized recloseable storage bags. Exemplary in-home dispensing devices are discussed in greater detail herein.

As used herein, “retail dispenser” refers to a container or other device which may be provided at the retail point of sale wherein the device may store or retain a plurality of packages. In certain embodiments, a retail dispenser may provide an individual packages upon dispensation to a consumer, the packages containing products such as flexibly wrapped packages having recloseable storage bags, for retail sale. A retail dispenser may or may not be refillable at the retail location. Exemplary retail dispensers are described in U.S. Pat. Nos. 3,356,279, 4,401,255, and 7,658,317 and are discussed in greater detail herein.

As used herein, “bag closure” generically refers to any integral zipper or slider or other opening and closing a recloseable storage bag. Nonlimiting examples of are described in U.S. Pat. Nos. 5,647,100 and 7,137,736 to the S.C. Johnson & Son, Inc. One of skill in the art may appreciate that due to their mechanical nature and due to the need for providing an area that a user may grip, recloseable storage bags have a lump at the point at which the bag closure is located. That is, because of the integral bag closures, a recloseable storage bag may not be perfectly flat. In certain embodiments, a bag closure is parallel with the cross-machine direction of the recloseable storage bags. Bag closures do not include drawstrings, handles extending from the recloseable storage bag which may be tied, or unattached mechanical closures, such as clips or twist ties.

### Existing Packaging for Recloseable Storage Bags

Many consumers are concerned about the amount of packaging on groceries and consumer items, such as consumer packaged goods, as being overpackaged or having too much outer material for the amount of product contained. While some producers of recloseable storage bags have made a number of strides in providing excellent packaging, such as the S.C. Johnson & Son, Inc. which produces Ziploc® Brand recloseable storage bags, which is constructed from recycled material, there is still an opportunity to provide consumers with a product that even further addresses their concerns about minimizing packaging while at the same time not detracting from their overall experience with the product.

A large part of a consumer's experience with the packaging as it relates to a recloseable storage bag is how the packaging serves as a dispenser for the recloseable storage bag. Many consumers are familiar with the cartons in which recloseable storage bags are sold. Because the box also serves as a dispenser, consumers often put multiple open boxes into a drawer or cabinet space to provide the different bags that a consumer may need. Unfortunately, the boxes are often tossed around with normal dispensing of bags causing confusion and delay in the future accessing of bags from the drawer or cabinet space.

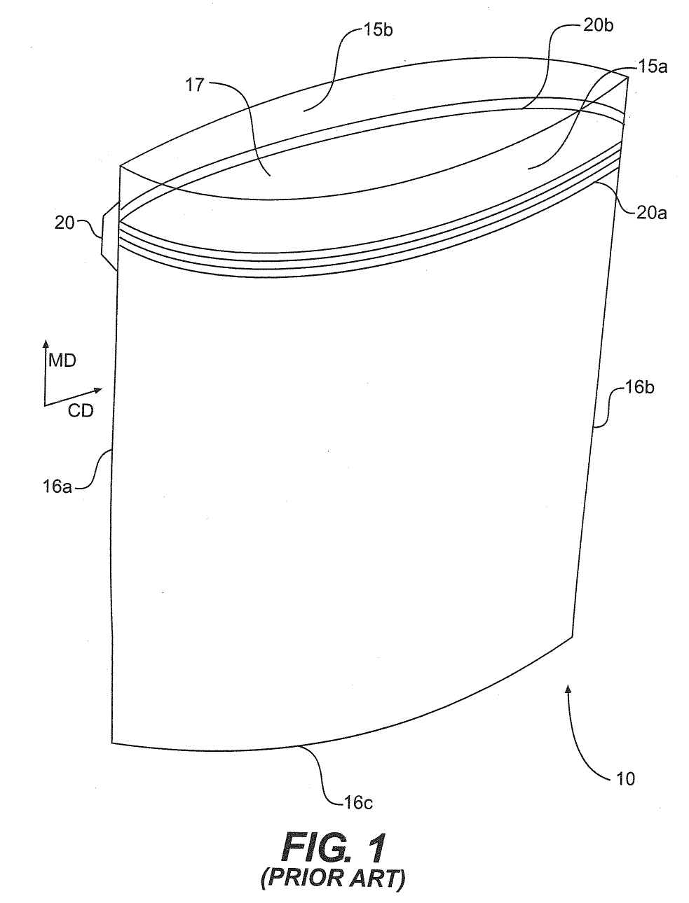

FIG. 1 provides a perspective view of an exemplary embodiment of a recloseable storage bag 10 which is available on the market. The recloseable storage bag 10 comprises a machine direction (MD) and a cross-machine direction (CD). Additionally, the recloseable storage bag 10 comprises has a first side 15a and a second side 15b that are in a coplanar orientation. The recloseable storage bag 10 is sealed along a first edge 16a, second edge 16b, and third edge 16c. There is an opening 17 between the first side 15a and second side 15b. The bag may also comprise a bag closure 20. In the embodiment shown in FIG. 1, the bag closure 20 comprises a first closure element 20a may be disposed along the first side 15a near the opening 17. A second closure element 20b may be disposed along the second side 15b opposite to the first closure element 20a such that the first closure element 20a and second closure element 20b may be put into mechanical communication, or otherwise mechanically engageable. One of skill in the art will appreciate that the first and second closure elements may be of any feature type that is appropriate for the recloseable storage bag's intended application such as is exemplified in U.S. Pat. Nos. 5,647,100 and 5,722,128 to S.C. Johnson & Son., Inc. Further still, one of skill in the art will appreciate that the recloseable storage bag 10 may not have first and second closure elements (20a, 20b), but may be closed by another means, such as, but not limited to: sliders, adhesive, hook-and-loop fasteners, and the like.

In many commercial operations, a recloseable storage bag may be formed according to methods and using equipment such as those described in U.S. Pat. Nos. 5,405,561, 5,554,250, 5,544,471, and 5,890,344.

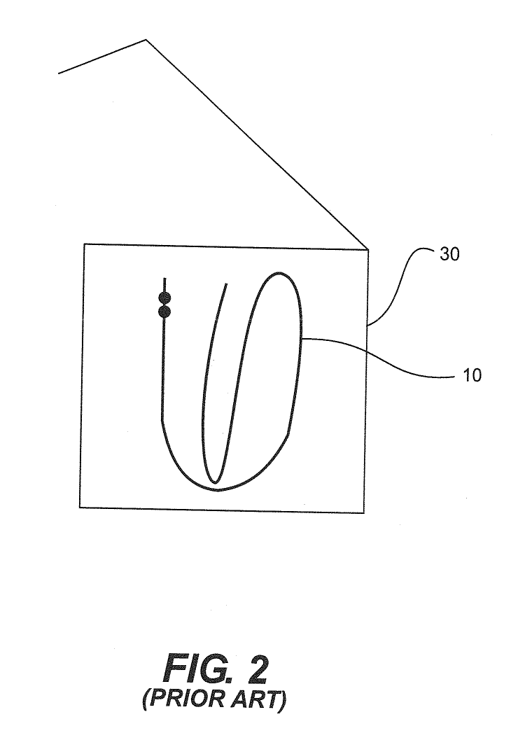

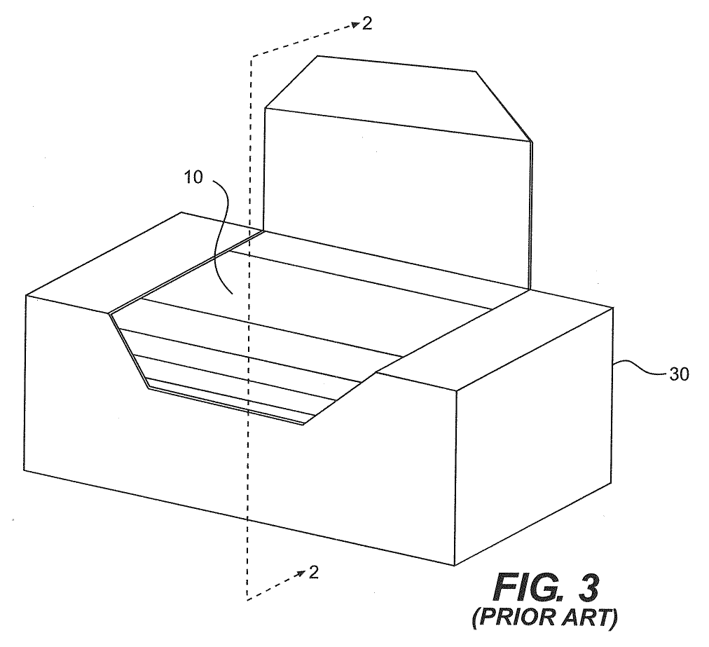

Upon manufacture, a stack of bags may then be double C-folded by an automated system and then stuffed into a carton or box for shipment to a retail location for sale. Despite automation, it is thought that there is a certain level of consistency in how bags are oriented in a box once the filled box reaches consumers due to the inherent amount of free space there is in a box. Further, the double C-folding technique which most automated processes use provides for non-aligned zippers on the bags and/or asymmetry of the bags during dispensing due to the inherent movement of the bags in the box. Both of which are thought to have a certain impact on the way in which a recloseable storage bag is dispensed from a box. FIG. 2 provides an exemplary cross-sectional view of a box 30 taken along line 2-2 (FIG. 3) having a plurality of double C-folded bags 10.

FIG. 3 provides a perspective view of an exemplary embodiment of an existing storage/dispensing box 30 in which recloseable storage bags 10 may be loaded into for retail distribution and sale. The box 30 may arrive for sale at a retail location in a completely sealed configuration. The box may comprise perforations 37, lines of weakness, or some other means by which recloseable storage bags 10 contained inside may be exposed for consumer access. Upon tearing of the box 30 along the perforations 10, an opening provides access to the recloseable storage bags 10. As stated herein, consumers have difficulties accessing only one bag at a time when such bags are provided in a box 30, leading to consumer frustration and failure to differentiate experientially from an un-branded product. As stated above, is thought that many of these difficulties arise from a combination of asymmetry about the point at which a bag may be grabbed by a consumer due to bags shifting in the open space available in the boxes and consumers grabbing multiple layers of film—thereby grabbing multiple bags—at once.

### Retail System for Providing a Complete Customer Experience

As stated herein, in alternative to providing some new feature on a product, the present invention surprisingly differentiated itself from existing recloseable storage bag products by provide a superior overall consumer experience for the use of a recloseable storage bag as that experience relates from the retail shelf, to the home, to actual use. More specifically, instead of focusing on a point-solution that improved a single aspect of the invention (i.e., ease of closure, etc.), the entire usage-cycle of a recloseable storage bag is enhanced.

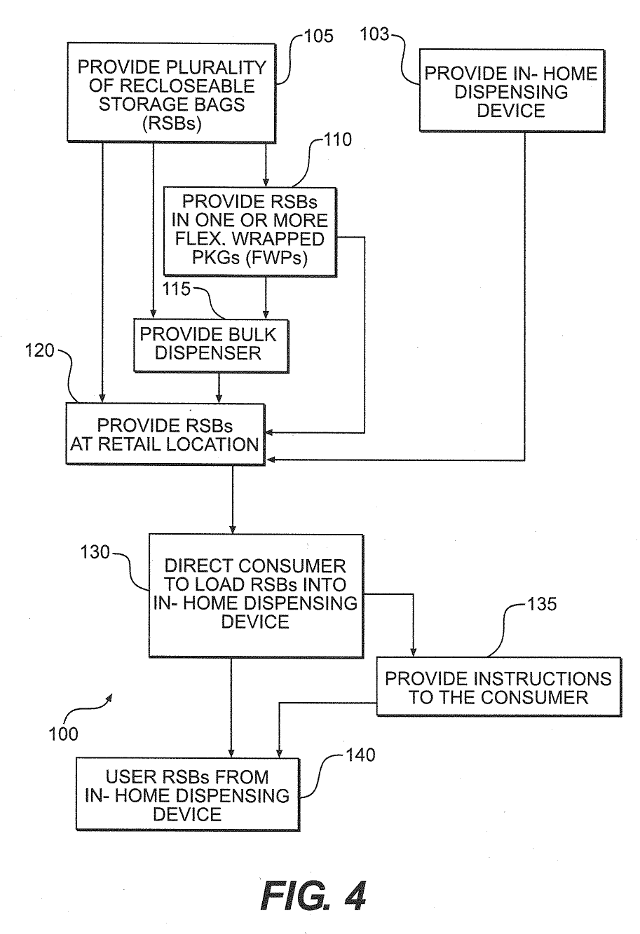

FIG. 4 provides an exemplary flow diagram illustrating the basis for a system, or in the alternative—a method of providing, recloseable storage bags and/or recloseable storage bag refills for an in-home dispensing unit 100.

A plurality of recloseable storage bags is provided 105. Separately, an in-home dispensing device may be provided 103. Optionally, the plurality of recloseable storage bags provided in 103 may be packaged in one or more flexibly wrapped packages 110. Also optionally, a bulk dispenser may be provided by the producer of the flexibly wrapped recloseable storage bags for sale to consumers 115. Without wishing to be limited by any particular embodiment, a bulk dispenser may include a merchandiser as described herein. Optionally still, the flexibly wrapped recloseable storage bags may then be provided in the bulk dispenser at the retail location for sale to customers 117. The recloseable storage bags are then provided for sale to customers at the retail location 120. In the exemplary embodiment, upon purchase of the recloseable storage bags, the customer may be directed to load the recloseable storage bags into an in-home dispensing device which the consumer has purchased 130 and then to use the recloseable storage bags in the dispenser 140. Once loaded, the consumer may remove recloseable storage bags from the in-home dispensing device. Optionally, a consumer may be provided with instructions on special loading techniques and methods 135 which are described in greater detail herein. Surprisingly, it was discovered that by providing an in-home dispensing system, consumers are delighted by having a relatively high level of organization in their drawer, ease by which they can access the recloseable storage bags, and the overall good feeling that the consumer may have from purchasing a product with relatively minimized packaging.

### Flexibly Wrapped Recloseable Storage Bags

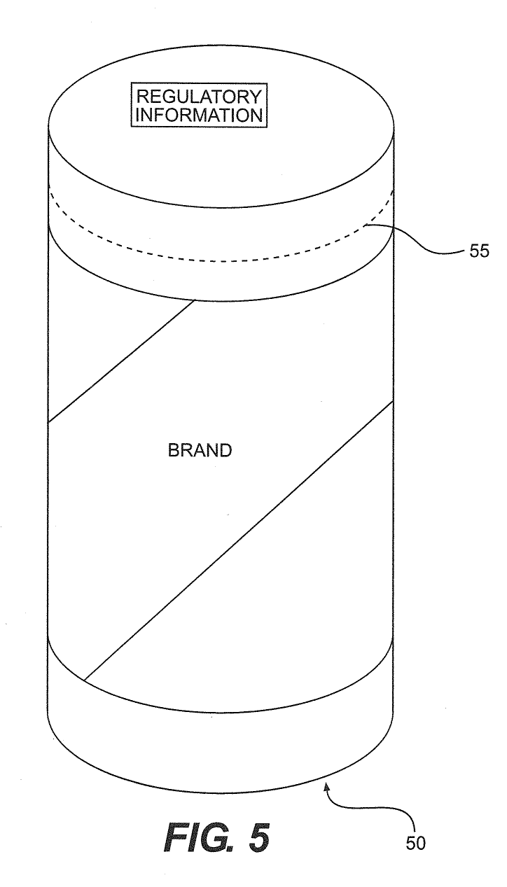

Any suitable automated system for providing an overwrap around consumer goods may be used to provide a flexibly wrapping around a plurality of recloseable storage bags. By providing such a minimized amount of packaging, it is thought that consumers will have a favorable response because of the dramatic amount of packaging that they will not have to discard and/or recycle. The flexibly wrapped recloseable storage bag may be made of any suitable plastic or otherwise flexible material, paper, biomaterial and/or recyclable. An exemplary embodiment of a flexibly wrapped plurality of recloseable storage bags 50 is shown in FIG. 5.

In addition to consumer packaging concerns, it is thought that an additional advantage to providing consumers with a flexibly wrapped execution for recloseable storage bags is that consumers will also the 360° available for providing graphics will allow for more versatile information and branding opportunities. Further, the packaging reduction will allow the producer to pass on savings to the consumer—leading to an overall increase in utility. In some embodiments, the flexibly wrapped recloseable storage bags may be provided with a perforation, tear strip, point of weakness, or the like to provide ease of access to the consumer. In the embodiment shown in FIG. 5, the flexible wrapping/packaging is provided with a line of perforations 55.

### In-Home Dispensing Device

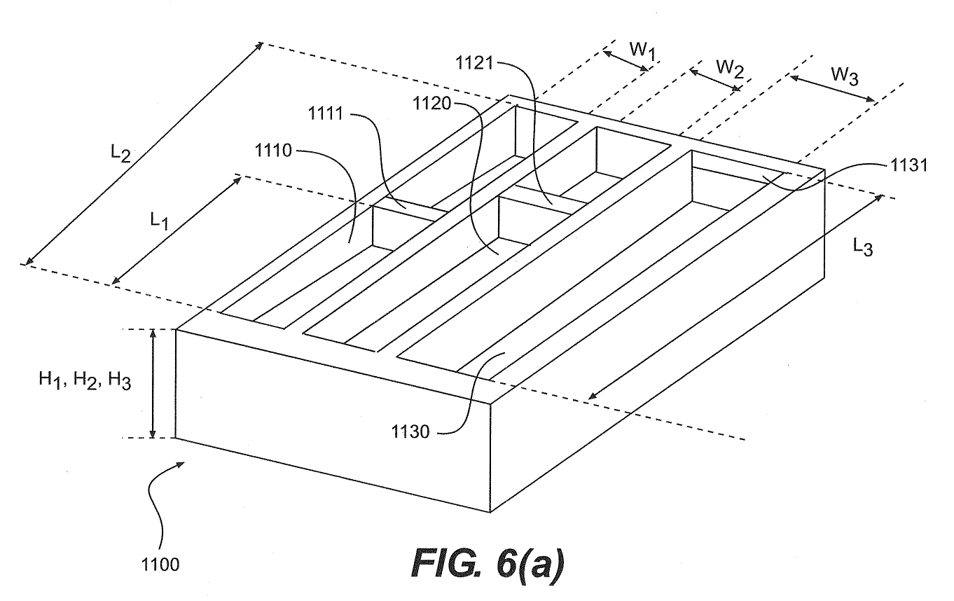

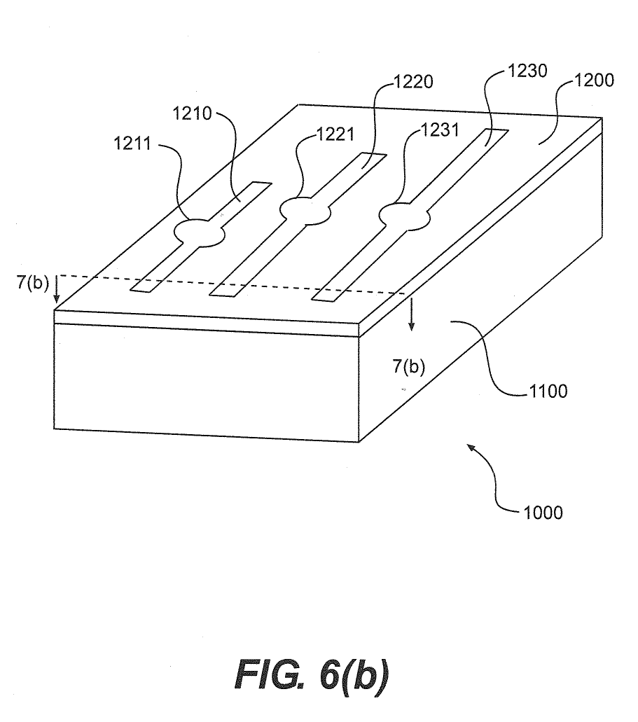

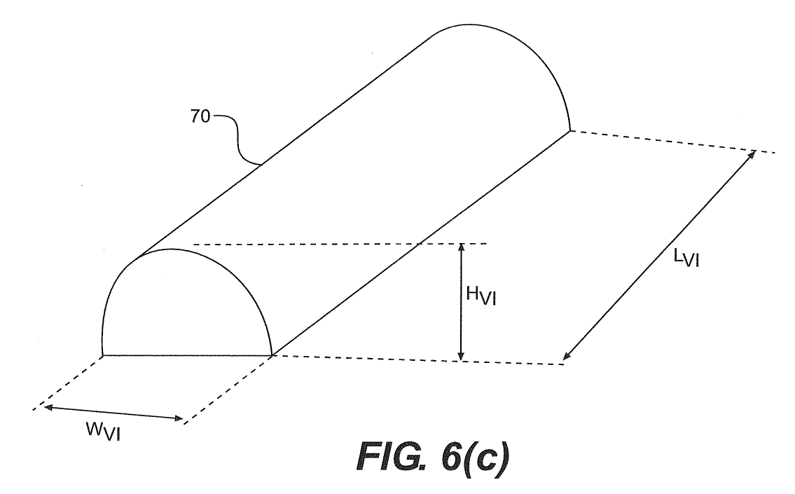

An exemplary embodiment of the base of an in-home dispensing device for recloseable storage bags is shown in FIG. 6(a). In addition to limitations discussed earlier, it is thought that a major issue that consumers have with existing boxes for recloseable storage bags is that most consumers use multiple types of bags which come in multiple boxes and the boxes may not necessarily tessellate easily and become randomly jumbled after each use. By providing a durable structure for consumers to load/reload, the consumer will not be constantly faced with having to tessellate and re-tessellate her drawer or pantry (or other space where she keeps her recloseable storage bags) which will add to the delight of using recloseable storage bags in day-to-day life. In certain embodiments, the recloseable storage bags are also designed to simply dispense from the in-home dispensing device which will reduce or eliminate any frustration that the consumer feels with many of the existing boxes, such as having multiple unwanted recloseable storage bags inadvertently dispense. Further, by having a durable structure for a dispensing device, packaging for the recloseable storage bags may be greatly reduced as a flexibly wrapped package may be used to provide a plurality of food storage containers to consumers and the consumers may rely on the in-home dispensing device, rather than a mere box, to provide products.

FIG. 6(a) comprises the base 1100 of an in-home dispensing device 1000 structure having a first compartment 1110, a second compartment 1120, and a third compartment 1130 in which recloseable storage bags may be loaded. One of skill in the art will appreciate that there may be any number of compartments for different (or identical) sized bags. As discussed above, it is thought that by providing a single dispenser for multiple units, then the issue of a consumer's drawer being jumbled will be reduced. In some embodiments, the width of a compartment (W₁ or W₂ or W₃) may be from about 1 inch to about 4 inches. In some embodiments, the length of a compartment (L₁ or L₂ or L₃) may be from about 3 inches to about 15 inches. In some embodiments, the height of a compartment (H₁ or H₂ or H₃) is from about 1 inch to about 4 inches. The compartments (1110, 1120, and 1130) base 1100 may also comprise removably attached, or slideably attached, spacer (1111, 1121, 1131) which may be used and/or adjusted to hold loaded recloseable storage bags in-place.

FIG. 6(b) is an exemplary embodiment of a complete in-home dispenser 1000. The dispenser 1000 comprises the base 1100 and a coordinating lid 1200 which may be removable affixed to the base by any suitable means known in the art. The lid 1200 may comprise one or more access slots (1210 or 1220 or 1230) which may provide a consumer with access to recloseable storage bags (not shown) loaded into the dispenser 1000. The access slots (1210, 1220, or 1230) coordinate spatially with the compartments (1110, 1120, or 1130), respectively. The access slots (1210, 1220, or 1230) may also comprise extensions (1221, 1221, or 1231) to provide a relatively easier level of access to the recloseable storage bags. In some embodiments, the access slots have a smaller surface area than the area of the base of the compartments.

It is thought that by providing a refill stream for the container, it may be possible to delight consumers by instructing the to remove the recloseable storage bags from their flexibly wrapped packaging and then loading the recloseable storage bags into the dispensing device (130, FIG. 4). In certain embodiments, instructions may be included, provided or otherwise conveyed in a flexibly wrapped package directing the consumer to an optimal loading configuration. Exemplary optimal loading configurations are described in greater detail herein.

FIG. 6(c) provides an exemplary embodiment of a volume insert 70 which may be removably, or permanently, integrated into a compartment of an in-home dispensing unit. One of skill in the art will appreciate that the height (H_{VI}), width (W_{VI}), and length (L_{VI}) of a volume insert may be specifically tailored to fit each compartment. As is discussed herein, it is thought that a major drawback to the use of a box (30, FIG. 2) to dispense bags (10, FIG. 1) is that there is a large amount of unoccupied volume between the bags and the enclosure of the box. Due to this fact, the bags shift around during transportation and use, and bags may no longer be properly aligned or optimally aligned for individual bag dispensing despite the box being pre-loaded in a properly aligned, or otherwise optimal, configuration. By providing a volume insert, the free space around bags may be minimized, providing for a better dispensing experience. A volume insert 70 may optimized for a particular in-home dispenser to provide a tight fit that may not be possible to provide using an automated system.

In some embodiments, a volume insert 70 may be spring-loaded or provide some other means of resistance to provide a relatively consistent amount of volume reduction in each compartment. In some other embodiments, a volume insert may be adjustable in terms of volume so that a user can customize the amount of volume she wants reduced in any compartment.

### Optimal In-Home Dispenser Configuration

As described herein, certain embodiments of the invention may further comprise the benefit of individual recloseable storage bag dispensation in addition to the other user benefits (inter alia, reduced packaging, neater shelves/storage spaces, and the like). A volume insert (70, FIG. 6(c)) may be used to minimize the amount of free space in which a plurality of recloseable storage bags may have to become mis-configured or lose a particular on-shelf configuration.

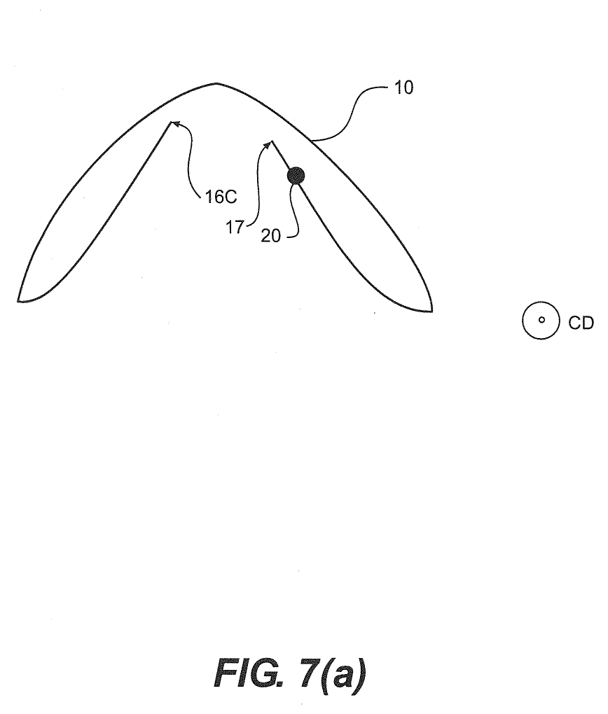

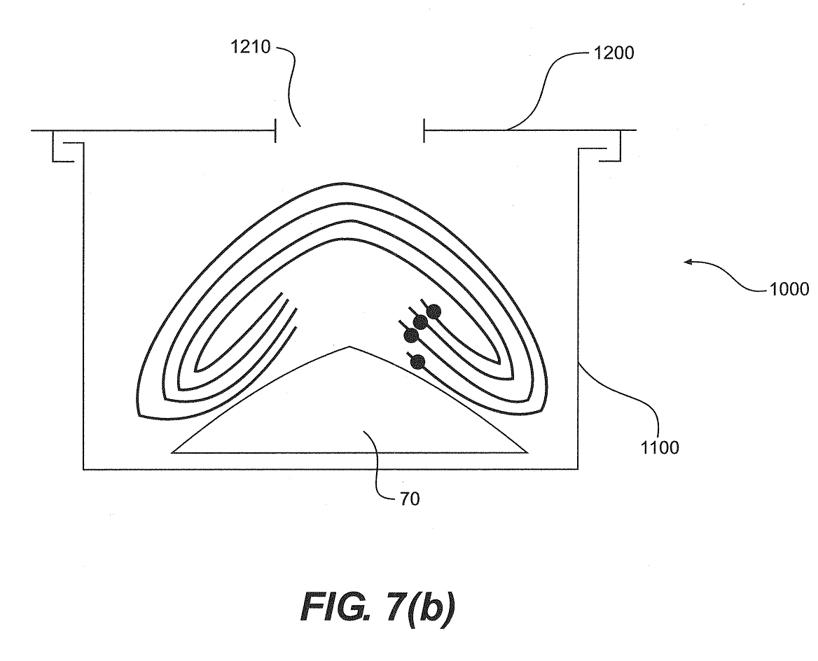

Without wishing to be limited by theory, one configuration which would provide for individual bag dispensation is shown in FIG. 7(a). The bag 10 is substantially symmetrical (bag closure 20 notwithstanding for symmetry purposes) about the center-line of the bag in the cross-machine direction (CD). In FIG. 7(a), the recloseable storage bag is folded such that the third edge 16(c) and the side with the opening 17 are on the relative underside of the folded bag 10. It is contemplated that the third edge 16(c) and side relatively adjacent to the opening 17 may be on the relative topside of the folded bag 10—the topside being understood to be the side of the folded bag facing relative to the access slot of whatever dispenser is being used. FIG. 7(b) shows a plurality of bags in a stack wherein the bags have been folded into a symmetrical-about-the-CD configuration.

One of skill in the art may appreciate that, while folding and arranging bags along the CD of the bag is preferred, it is possible to apply any configuration described herein in the MD as well.

FIG. 7(b) shows the bags 10 as they may be provided in a dispenser 1000 having a base 1100 and lid 1200. It is thought that a consumer may access bags through an access slot 1210 thereby facilitating a relative symmetrical access to the bags 10 and providing actual individual dispensation of the bags 10. Optionally, a volume insert 70 may be provided to minimize free space in the compartment in which the bags are stored. As is shown in FIG. 7(b), the plurality of bags may be provided such that the recloseable storage bag closures 20 are all aligned or are otherwise configured such that they are all on the same relative side or edge of the recloseable storage bags. An instruction may be provided to configure the recloseable storage bags such that the bag closures 20 are all on the same relative side or edge of the recloseable storage bags.

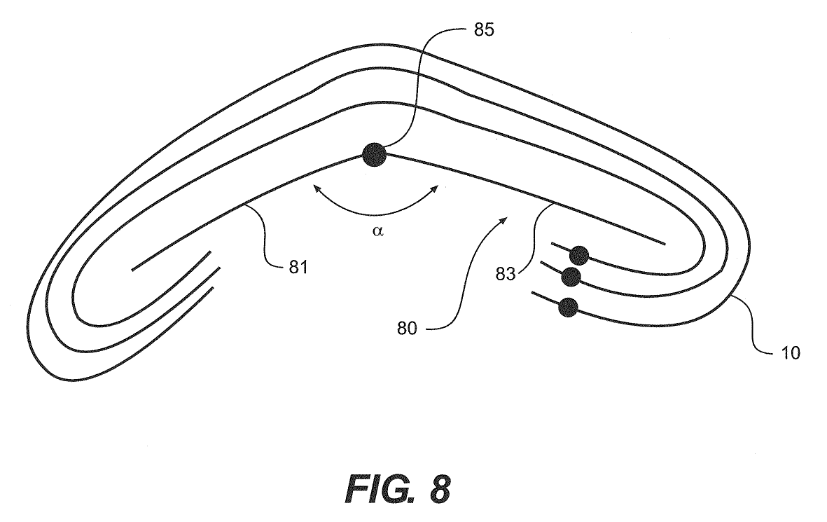

FIG. 8 provides an alternative arrangement by which a plurality of recloseable storage bags 10 may be provided about a shape holder 80. The shape holder 80 may have a first wing 81 and a second wing 83 and a center line 85. It is thought that by arranging the bags such that the machine direction of the recloseable storage bags 10 is parallel with the center line 85, and by providing the wings (81, 83) such that the third edge 16c and end of the bag with the opening 17 may be folded about the wings (81, 83), when arranged in a compartment in such a way that the bags are facing the access slot of the compartment, then only one bag at a time will be dispensed. In some embodiments, a shape holder 80 may be used in conjunction with a volume insert 70. In other embodiments the wings (81, 83) form an obtuse angle a about the center line 85.

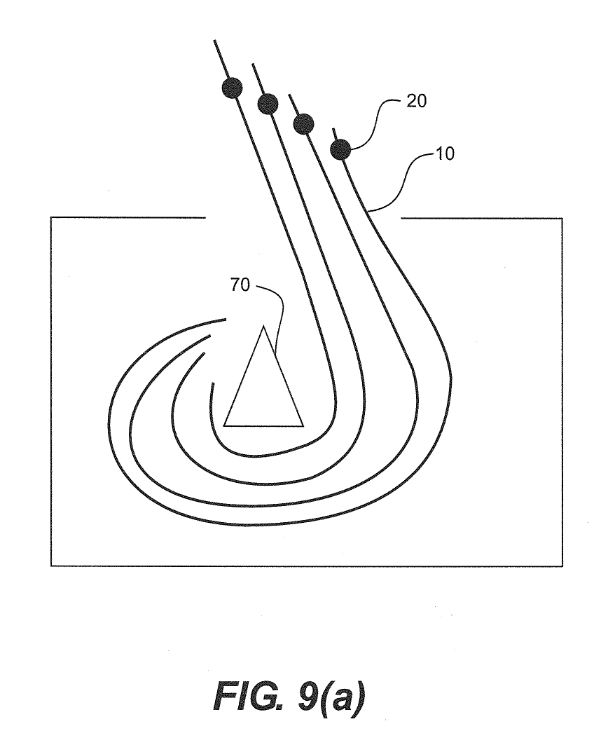

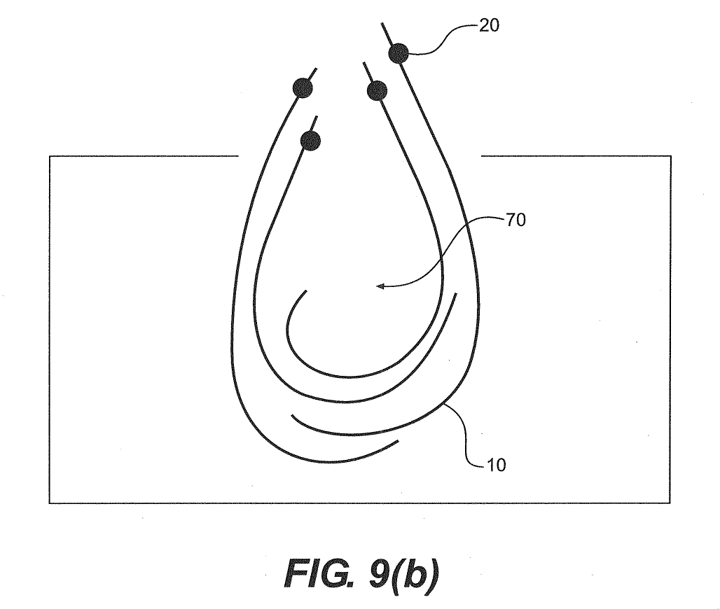

FIG. 9(a) provides an alternative arrangement by which a plurality of recloseable storage bags 10 may be provided such that the bag closures 20 are aligned in the same direction and are staggered. By providing the staggered configuration and then rolling the bags such that they will fit into a compartment, it is thought that such an arrangement will provide the bag closures 20 such that the closures act as handles or grips for the consumer to easily withdraw one bag at a time. In the exemplary FIG. 9(a), the bags 10 are provided such that the bag closures 20 are staggered and the stack of bags 10 is rolled such that the bag closures 20 are provided in a compartment such that the bag closures are relatively accessible to a consumer through an access slot in the manner described herein. An optional volume insert 70 may be used to provide as a stabilizing unit to hold the bags 10 in place to aid in maintaining the bag configuration.

In the exemplary FIG. 9(b), the bags 10 are provided such that the bag closures 20 are staggered and the stack of bags are arranged such that the bag closures 20 are not all arranged in the same direction. In the embodiment of FIG. 9(b) the bags are arranged such that the bag closures are alternating in directions. In FIG. 9(b) the bags 10 is rolled such that the bag closures 20 are provided in a compartment such that the bag closures are relatively accessible to a consumer through an access slot in the manner described herein. An optional volume insert 70 may be used to provide as a stabilizing unit to hold the bags 10 in place to aid in maintaining the bag configuration.

In addition to the configurations described herein, it may be possible to provide the user with recloseable storage bags in a configuration such as C-, or Z-folded. Exemplary configurations are described in U.S. Pat. No. 5,626,572.

### In-Store Dispensing Device

Manufacturers of round canned goods, such as canned soup, often have spring-loaded or gravity-fed shelf units on-shelf at a retail location for dispensing their canned products. Such dispensing units are exemplified herein. A similar dispensing method may be used to dispense a flexibly wrapped package according to the present invention. In one embodiment, it is thought that pre-filled merchandisers may be provided to retailers so that a clerk or stock person at a retail location may simply open a merchandiser according to the producer's directions and the merchandiser will be ready for consumer access.

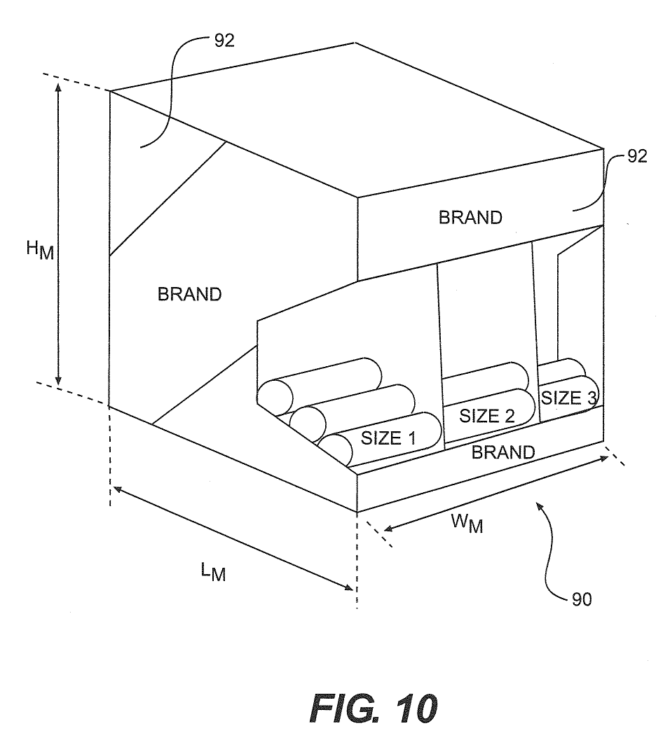

FIG. 10 provides an exemplary embodiment of an opened merchandiser 90. As shown in FIG. 10, the dispensing unit may be substantially enclosed and may dispense one or more sizes of flexibly wrapped recloseable bags. The merchandiser may be made of any material such as a corrugated fiberboard, solid fiberboard, chipboard, or the like. In one embodiment, it is thought that it is possible to provide multiple SKUs into a single merchandiser unit, there will be a relatively minimal out-of-stock potential for the merchandiser. In another embodiment, there is only a single SKU per merchandiser.

In one embodiment the merchandiser 90 may have a height (H_{M}) of from about 5 inches to about 55 inches. In a preferred embodiment, the height is from about 5 inches to about 10 inches. In another embodiment the merchandiser 90 may have a length (or depth) (L_{M}) of from about 5 inches to about 50 inches. In a preferred embodiment, the length is from about 5 inches to about 11 inches. In another embodiment still the merchandiser has a width of from about 5 inches to about 50 inches. In a preferred embodiment, the width is from about 5 inches to about 10 inches. Further, because rather than having a plurality of packages having identical, relatively small, graphics, it will be possible to have a single, relatively large, “billboard” 92 type communication across the merchandiser. It is thought that this will help attract consumers to the display. Communications including, but not limited to, instructions, promotions, QR codes, bar codes, and the like could be prominently displayed on the billboard. In some embodiments, the merchandiser may provide packages using a gravity fed-type mechanism. In other embodiments, the merchandiser may provide packages using a spring-loaded mechanism.

In all of the configurations described herein, it should be understood that the configurations of the recloseable storage bags may be provided to the consumer ready to go out of any retail packaging, such as flexible packaging. However, in other embodiments, a user may be directed to further manipulate the recloseable storage bags for optimal use in any in-home dispensing unit that may be provided and/or otherwise used.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “50 mm” is intended to mean “about 50 mm.”

All documents cited in the Detailed Description of the invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

We claim:

1. A process for providing a recloseable storage bag to a consumer wherein the process comprises the steps of:
a) providing a plurality of recloseable storage bags; and
b) directing consumers to load the plurality of recloseable storage bags into an in-home dispenser.

2. The process according claim 1 wherein the plurality of recloseable storage bags are provided in a flexibly wrapped package.

3. The process according to claim 1 wherein the plurality of recloseable storage bags are provided in a merchandiser which is pre-filled by the producer.

4. The process according to claim 1 further comprising the step of:
a)(1) providing consumers with an in-home dispensing unit; wherein step a)(1) is after step a) and before step b).

5. The process according to claim 4 further comprising the step of:
a)(2) providing directions to the consumer for specifically loading the in-home dispensing unit; wherein step a)(2) is after step a) and before step b).

6. The process according to claim 5 wherein the directions of step a)(2) comprises the step of a)(2)(i) providing the bags in a substantially symmetrical configuration about the cross-machine direction in a compartment of the in-home dispensing unit.

7. The process according to claim 4 further comprising the step of a)(3) providing consumers with a volume insert for the in-home dispensing unit; wherein step a)(3) is after step a)(1).

8. The process according to claim 7 wherein the directions of step a)(2) comprises the step of a)(2)(i) providing the bags in a substantially symmetrical configuration about the cross-machine direction in a compartment of the in-home dispensing unit, wherein the compartment has been provided with a volume insert.

9. A process for providing a recloseable storage bag to a consumer wherein the process comprises the steps of:
a) providing a plurality of recloseable storage bags in a flexibly wrapped package; wherein the flexibly wrapped package is substantially cylindrical; and
b) directing consumers to load the plurality of recloseable storage bags into an in-home dispenser.

10. The process according to claim 9 further comprising the step of:
a)(1) providing the plurality of flexibly wrapped packages in a merchandiser.

11. The process according to claim 10 wherein the merchandiser provides packages with a gravity-fed mechanism.

12. The process according to claim 10 wherein the merchandiser has a width of from about 5″ to about 10″.

13. The process according to claim 10 wherein the merchandiser has a length of from about 5″ to about 11″.

14. A process for providing a recloseable storage bag to a consumer wherein the process comprises the steps of:
a) providing a plurality of recloseable storage bags in a merchandiser; and
b) directing consumers to load the plurality of recloseable storage bags into an in-home dispenser; wherein the in-home dispenser comprises one or more compartments.

15. The process according to claim 14 further comprising the step of:
c) directing the consumers to load the plurality of recloseable storage bags in a configuration that is substantially symmetrical about the cross-machine direction of the bag into the in-home dispenser; wherein step c) is after step b).

16. The process according to Step 15 further comprising the step of:
d) directing the consumer to provide all bag closures on the recloseable storage bags to be on the same relative side of the bag; wherein step d) is after step c).

17. The process according to Step 15 further comprising the step of:
c)(1) directing the consumers to load the plurality of recloseable storage bags such that a third edge of the bag and a side adjacent to an opening of the bag are on the relative underside of the bag.

18. The process according to claim 14 further comprising the step of:
c) directing the consumers to load the plurality of recloseable storage bags in a configuration wherein bag closures are all facing the same side and wherein the bag closures are staggered and wherein the bag closures are facing towards an access slot of the in-home dispenser; wherein step c) is after step b).

19. The process according to claim 14 further comprising the step of:
o) providing a plurality of recloseable storage bags to a retailer;
oo) directing the retailer to provide the recloseable storage bags into a merchandiser; wherein steps o) and oo) are before step a).

20. The process according to claim 19 further comprising the step of:
o′) providing a merchandiser to the retailer; wherein step o′) is after step o).
